(19) United States
(12) Patent Application Publication
(10) Pub. No.: US 2006/0276563 A1
(43) Pub. Date: Dec. 7, 2006

(54) Easily dispersible pigments with fast colour intensity development

(76) Inventors: Frank Osterod, Liederbach (DE); Carsten Plueg, Ober-Beerbach (DE); Hans Joachim Metz, Darmstadt (DE)

Correspondence Address: CLARIANT CORPORATION;INTELLECTUAL PROPERTY DEPARTMENT, 4000 MONROE ROAD, CHARLOTTE, NC, 28205, US

(21) Appl. No.: 10/553,819

(22) PCT Filed: Apr. 8, 2004
(86) PCT No.: PCT/EP04/03760

§ 371 Date: Oct. 19, 2005

(30) Foreign Application Priority Data
Apr. 22, 2003 (EP) 103 18 235.7

(51) Int. Cl. C03C 17/00

(52) U.S. Cl. 523/160; 523/200

(57) ABSTRACT

The invention relates to a method for the pigmentation of a non-aqueous, organic coating material containing a solvent. The invention is characterised in that a coated, finely dispersed organic pigment with (meth)acrylate copolymers containing amino groups is incorporated into an organic coating material containing a solvent, said pigment having a discharge of energy which is reduced by at least 20% compared to the corresponding non-coated pigment.

The surface modification of pigments using pigment derivatives and compounds of low molecular mass is known, though in many cases the performance with regard to ready dispersibility in the application medium is inadequate.

Easy-to-disperse pigments or solid pigment preparations, also encountered in the technical literature under the designation of stir-in pigments, have already been the subject of numerous investigations. In order to ensure high, universal compatibility with the application medium, it is necessary to select a high pigment concentration, which in numerous liquid pigment preparations is non-achievable.

EP-0 902 061 describes how by coating the surface with vinylpyrrolidone polymer and/or copolymer a modified pigment powder is obtained which without using a ball mill can be incorporated into an aqueous printing and grinding system.

EP-0 702 062 describes the modification of pigments with rosin, an aqueous suspension of pigment, alkali metal salt of a rosin acid, and a filler being ground in a horizontal ball mill. Adding a metal salt allows the stir-in pigment to be isolated.

WO 02/26892 discloses a process for preparing polymer-enrobed pigment particles wherein, with finely divided pigment particles present, a solution of a polymer in a first solvent is mixed with a second solvent which has very little or no solvency for the polymer but is miscible with the first solvent. Prior to mixing, the pigment particles may be in finely divided form in the solution of the polymer in the first solvent and/or in finely divided form in the second solvent. The turbulent mixing of the two solvents causes the polymer's solubility limit to be exceeded and the polymer to be precipitated on the pigment surface. It thus encapsulates the pigment particles. This process has the disadvantage, however, that the product is a low-pigment-content dispersion and the dispersion, moreover, contains environmentally objectionable organic solvents. Isolating the polymer-enrobed pigment particles here also necessitates expensive distillation of both solvents or energy-intensive spray drying.

The object, then, was to provide a technically simple and environmentally unobjectionable method of pigmenting solventborne organic coating materials, such as paints and inks, wherein organic pigments can be incorporated in said organic paints and inks with minimal shearing forces and maximum, fast color intensity development.

Surprisingly it has been found that pigments surface-coated with certain copolymers exhibit very high suitability as stir-in pigments for organic coating materials, with an increase in color intensity development at the same time.

The invention provides a method of pigmenting a solventborne, nonaqueous organic coating material which comprises incorporating a finely divided organic pigment coated with amino-containing (meth)acrylate copolymers into a solventborne organic coating material with an energy input reduced by at least 20% as compared with the corresponding uncoated pigment.

The stir-in pigments produced in accordance with the invention develop their high color intensity by being stirred simply and with short duration into the solventborne organic coating material: for example, by 5-minute to 3-hour stirring, preferably 15- to 45-minute stirring, in a dissolver with a toothed disk, so that there is no need for more extensive, expensive dispersing steps in the stated application medium.

The production of the coated pigments, too, is characterized by a simple procedure. Costly and inconvenient isolation by means of expensive distillation steps of the entire liquid phase or by spray drying is unnecessary. In addition, the method of the invention is applicable in principle to all organic pigments, since there is no sharp change in pH, as described in EP-0 702 062 for producing stir-in pigments by means of soluble alkali metal salts of various resins.

In one preferred embodiment the finely divided, coated organic pigment is obtained by mixing an aqueous, finished presscake of the organic pigment with water and carrying out deagglomeration in a static mixer in the presence of the amino-containing (meth)acrylate copolymer, then subjecting the deagglomerated mixture to steam distillation, isolating the solid by filtration, and drying it. Said aqueous presscake of the organic pigment is composed of pigment which has been finely divided, ground for example, and, if desired, finished. The techniques of fine division and finishing that are the most favorable in each case are dependent on the identity of the pigment and are known to the skilled worker. The aqueous presscake is diluted with water to a solids content of preferably 5% to 30% by weight.

Added to the aqueous suspension obtained in this way is a solution of the amino-containing (meth)acrylate copolymer or of a mixture of such copolymers. The amount of this solution is calculated such that ultimately the amino-containing (meth)acrylate copolymer is applied in an amount of 5% to 50% by weight, especially 10% to 40% by weight, to the pigment, based on the total weight of the coated pigment. Suitable solvents for the amino-containing (meth)acrylate copolymers include, in particular, organic solvents which are immiscible or poorly miscible with water, such as butyl acetate, 1-butanol, 2-butanol, and isobutanol, or else solvent mixtures of these solvents with one another and also with methoxypropyl acetate.

In one particularly preferred embodiment the suspension, during or after the addition of the amino-containing (meth)acrylate copolymer, is subjected to deagglomeration in a static mixer, in which case it is particularly advantageous to pump the suspension repeatedly in circulation through the static mixer until a particle size d₅₀ of 0.05 to 40 μm, especially 0.1 to 10 μm, is attained.

Static mixers are comminution machines such as ball mills and bead mills with glass, porcelain or steel balls/beads. Also possible, furthermore, are dissolvers and comminuting machines of rotor/stator design. One particularly preferred embodiment uses a rotor/stator machine with high peripheral speeds. Common to all of the constructions is the ability to use a high energy component effectively for comminuting the pigment particles.

The stir-in pigment is isolated by removing the organic solvent to give an aqueous suspension. Steam distillation is found particularly advantageous. The surface-coated, easily dispersible stir-in pigment is obtained by filtration and final drying. If the stir-in pigment is obtained in the form of coarse grains, it is advantageously subjected to dry grinding in addition. The coated pigments produced in accordance with the invention generally have a specific surface area (BET) of between 5 and 30 m²/g, preferably 7 and 20 m²/g, especially 8 and 15 m²/g.

The organic pigment may be a pigment from the group of the azo pigments, such as monoazo, disazo, Naphtol, benzimidazolone, and metal complex pigments, or of the polycyclic pigments, such as isoindolinone, isoindoline, anthanthrone, thioindigo, thiazineindigo, triarylcarbonium, quinophthalone, anthraquinone, dioxazine, phthalocyanine, quinacridone, quinacridonequinone, indanthrone, perylene, perinone, pyranthrone, diketopyrrolopyrrole, isoviolanthrone and azomethine pigments.

Preferred organic pigments for the purposes of the present invention are, for example, C.I. Pigment Yellow 1 (C.I. No. 11 680), C.I. Pigment Yellow 3 (C.I. No. 11 710), C.I. Pigment Yellow 12 (C.I. No. 21 090), C.I. Pigment Yellow 13 (C.I. No. 21 100), C.I. Pigment Yellow 14 (C.I. No. 21 095), C.I. Pigment Yellow 17 (C.I. No. 21 105), C.I. Pigment Red 123 (C.I. No. 71 145), C.I. Pigment Red 149 (C.I. No. 71 137), C.I. Pigment Red 178 (C.I. No. 71 155), C.I. Pigment Red 179 (C.I. No. 71 130), C.I. Pigment Red 190 (C.I. 71 140), C.I. Pigment Red 224 (C.I. No. 71 127), C.I. Pigment Violet 29 (C.I. No. 71 129), C.I. Pigment Orange 43 (C.I. No. 71 105), C.I. Pigment Red 194 (C.I. No. 71 100), C.I. Pigment Violet 19 (C.I. No. 73 900), C.I. Pigment Red 122 (C.I. No. 73 915), C.I. Pigment Red 192, C.I. Pigment Red 202 (C.I. No. 73 907), C.I. Pigment Red 207, C.I. Pigment Red 209 (C.I. No. 73 905), C.I. Pigment Red 206 (C.I. No. 73 900/73 920), C.I. Pigment Orange 48 (C.I. No. 73 900/73 920), C.I. Pigment Orange 49 (C.I. No. 73 900/73 920), C.I. Pigment Orange 42, C.I. Pigment Yellow 147, C.I. Pigment Red 168 (C.I. No. 59 300), C.I. Pigment Yellow 120 (C.I. No. 11 783), C.I. Pigment Yellow 151 (C.I. No. 13 980), C.I. Pigment Brown 25 (C.I. No. 12 510), C.I. Pigment Violet 32 (C.I. No. 12 517), C.I. Pigment Orange 64; C.I. Pigment Brown 23 (C.I. No. 20 060), C.I. Pigment Red 166 (C.I. No. 20 730), C.I. Pigment Red 170 (C.I. No. 12 475), C.I. Pigment Orange 38 (C.I. No. 12 367), C.I. Pigment Red 188 (C.I. No. 12 467), C.I. Pigment Red 187 (C.I. No. 12 486), C.I. Pigment Orange 34 (C.I. No. 21 115), C.I. Pigment Orange 13 (C.I. No. 21 110), C.I. Pigment Red 9 (C.I. No. 12 460), C.I. Pigment Red 2 (C.I. No. 12 310), C.I. Pigment Red 112 (C.I. No. 12 370), C.I. Pigment Red 7 (C.I. No. 12 420), C.I. Pigment Red 210 (C.I. No. 12 477), C.I. Pigment Red 12 (C.I. No. 12 385), C.I. Pigment Blue 60 (C.I. No. 69 800), C.I. Pigment Green 7 (C.I. No. 74 260), C.I. Pigment Green 36 (C.I. No. 74 265); C.I. Pigment Blue 15:1, 15:2, 15:3, 15:4, 15:6 and 15 (C.I. No. 74 160); C.I. Pigment Blue 56 (C.I. No. 42 800), C.I. Pigment Blue 61 (C.I. No. 42 765:1), C.I. Pigment Violet 23 (C.I. No. 51 319), C.I. Pigment Violet 37 (C.I. No. 51 345), C.I. Pigment Red 177 (C.I. No. 65 300), C.I. Pigment Red 254 (C.I. No. 56 110), C.I. Pigment Red 255 (C.I. No. 56 1050), C.I. Pigment Red 264, C.I. Pigment Red 270, C.I. Pigment Red 272 (C.I. No. 56 1150), C.I. Pigment Red 71, C.I. Pigment Orange 73, C.I. Pigment Red 88 (C.I. No. 73 312), C.I. Pigment Yellow 175 (C.I. No. 11 784), C.I. Pigment Yellow 154 (C.I. No. 11 781), C.I. Pigment Yellow 83 (C.I. No. 21 108), C.I. Pigment Yellow 180 (C.I. No. 21 290), C.I. Pigment Yellow 181 (C.I. No. 11 777), C.I. Pigment Yellow 74 (C.I. No. 11 741), C.I. Pigment Yellow 213, C.I. Pigment Orange 36 (C.I. No. 11 780), C.I. Pigment Orange 62 (C.I. No. 11 775), C.I. Pigment Orange 72, C.I. Pigment Red 48:2/3/4 (C.I. No. 15 865:2/3/4), C.I. Pigment Red 53:1 (C.I. No. 15 585:1), C.I. Pigment Red 208 (C.I. No. 12 514), C.I. Pigment Red 185 (C.I. No. 12 516), C.I. Pigment Red 247 (C.I. No. 15 915), and C.I. Pigment Red 146 (C.I. No. 12 485).

It is also possible to use more than one organic pigment or mixed crystals (solid solutions) of organic pigments.

Particularly preferred pigments are C. I. Pigment Violet 23 (C. I. No. 51319) and C.I. Pigment Orange 36 (C.I. No. 11780).

The amino-containing (meth)acrylate copolymers are modified acrylate copolymers and methacrylate copolymers having an amine number of preferably 20 to 70 mg KOH/g, more preferably 25 to 55 mg KOH/g. The molar mass of suitable, modified acrylate copolymers and methacrylate copolymers is preferably between 2000 and 100 000 g/mol. Especially suitable copolymers have molar masses of between 5000 and 30 000 g/mol. The amino groups may also have been quaternized and may be present, for example, in ammonium salt form. The modified acrylate copolymers and methacrylate copolymers can be block copolymers, graft copolymers or random copolymers. Also possible is the use of specific macromonomers. The copolymer may contain monomer units from the group of acrylic acid and methacrylic acid, such as, for example, methyl (meth)acrylate, ethyl(meth)acrylate, n-propyl(meth)acrylate, n-butyl(meth)acrylate, isopropyl(meth)acrylate, isobutyl(meth)acrylate, amyl (meth)acrylate, isoamyl(meth)acrylate, hexyl(meth)acrylate, 2-hydroxyethyl(meth)acrylate, 2-hydroxypropyl(meth)acrylate, N,N-diethylaminoethyl(meth)acrylate, N,N-dimethylaminoethyl(meth)acrylate, N,N-dipropylaminoethyl(meth)acrylate, N,N-dibutylaminoethyl(meth)acrylate, N,N-dihexylaminoethyl(meth)acrylate, N,N-diethylaminobutyl(meth)acrylate, N,N-dimethylaminobutyl(meth)acrylate, N,N-dipropylaminobutyl(meth)acrylate, N,N-dibutylaminobutyl(meth)acrylate, N,N-dihexylaminobutyl(meth)acrylate, N,N-diethylaminopropyl(meth)acrylate, N,N-dimethylaminopropyl(meth)acrylate, N,N-dipropylaminopropyl(meth)acrylate, N,N-dibutylaminopropyl(meth)acrylate, N,N-dihexylaminopropyl(meth)acrylate, N,N-diethylaminohexyl(meth)acrylate, N,N-dimethylaminohexyl(meth)acrylate, N,N-dipropylaminohexyl(meth)acrylate, N,N-dibutylaminohexyl(meth)acrylate, N,N-dihexylaminohexyl(meth)acrylate, benzyl(meth)acrylate, allyl(meth)acrylate, 2-n-butoxyethyl(meth)acrylate, 2-sec-butyl (meth)acrylate, tert-butyl(meth)acrylate, 2-ethylbutyl(meth)acrylate, cyclohexyl(meth)acrylate, 2-ethoxyethyl(meth)acrylate, 3-methoxybutyl (meth)acrylate, 2-methoxybutyl(meth)acrylate, n-octyl(meth)acrylate, 2-ethylhexyl (meth)acrylate, 2-phenylethyl(meth)acrylate, phenoxyethyl(meth)acrylate, and phenyl(meth)acrylate.

Further possible monomer units are as follows: styrene, α-methylstyrene, vinyltoluene, acrylic acid, methacrylic acid, 9-vinylanthracene, 9-vinylcarbazole, vinylcyclohexane,

1-vinylimidazole, 2-vinylpyridine, 1-vinyl-1,2,4-triazole, and acrylnitrile.

The copolymer possesses no hydrophilic character or only slight hydrophilic character.

The application medium, i.e., the organic coating material to be pigmented, may be a solventborne baking varnish, a solventborne two-component varnish, or a printing ink or ink-jet ink. Solventborne in this context means that the customary solvents employed in the coatings industry, with the exception of water, are suitable.

Examples of suitable varnishes are alkyd-melamine resin varnishes, acrylic-melamine resin varnishes, polyester varnishes, and high-solids acrylic resin varnishes.

Particularly suitable application systems for the surface-modified, easily dispersible pigments are alkyd-melamine resin varnishes based on a medium-oil alkyd resin and a butanol-etherified melamine resin. The ratio of alkyd resin to melamine resin in the corresponding varnish is advantageously between 70:30 and 80:20. Likewise suitable are two-component varnishes based on an isocyanate-crosslinkable acrylic resin.

Solvent-based ink-jet inks can contain 0.5 to 15% by weight of the stir-in pigment of the invention, 85 to 99.5% by weight of organic solvent and/or hydrotropic compounds.

The solvents and/or humectants present in recording liquids may be monohydric or polyhydric alcohols, their ethers and esters, e.g., methanol, ethanol, propanol, isopropanol, butanol, and isobutanol; dihydric or trihydric alcohols, particularly of 2 to 6 carbon atoms, e.g., ethylene glycol, propylene glycol, 1,3-propanediol, 1,4-butanediol, 1,5-pentanediol, 1,6-hexanediol, 1,2,6-hexanetriol, glycerol, diethylene glycol, dipropylene glycol, triethylene glycol, polyethylene glycol, tripropylene glycol, and polypropylene glycol; lower alkyl ethers of polyhydric alcohols, such as ethylene glycol monomethyl, monoethyl or monobutyl ether, and triethylene glycol monomethyl or monoethyl ether; ketones and ketone alcohols, such as acetone, methyl ethyl ketone, diethyl ketone, methyl isobutyl ketone, methyl pentyl ketone, cyclopentanone, cyclohexanone, and diacetone alcohol; amides, such as dimethylformamide, dimethylacetamide, and

N-methylpyrrolidone; and also urea, tetramethylurea, thiodiglycol, and ε-caprolactam.

Examples 1 to 3 describe the preparation of the surface-coated, easily dispersible pigments and Examples I-V describe incorporation into an alkyd-melamine varnish. In the case of the initial mass of the surface-modified pigments, the surface coating was compensated by an adjustment to the initial mass. Percentages are by weight.

### EXAMPLE 1

A suspension of 364 g of Pigment Violet 23 (C.I. No. 51319, used in the form of a presscake) and 2500 g of water is deagglomerated using a static mixer (Laborpilot 2000, IKA, Staufen, Germany) at 6000 min−1 for 1 hour. Added to the suspension is a solution of 156 g of modified acrylate copolymer (10% vinylimidazole, 90% butyl methacrylate, amine number: 30 mg KOH/g, Mₙ=13 500 g/mol, M_{w}=31 000 g/mol), 144 g of methoxypropyl acetate and 2310 ml of isobutanol. The reaction mixture is deagglomerated with the static mixer for a further 60 minutes. Following a steam distillation the surface-modified Pigment Violet 23 is isolated by filtration and dried in a drying oven at 60° C. After final dry grinding (in a number of portions, using an IKA M 20 mill), 452 g of easily dispersible pigment violet are obtained.

### EXAMPLE 2

293.4 g of Pigment Violet 23 (C. I. No. 51319, used in presscake form) are admixed with 2.4 l of water and coarsely homogenized. Thereafter the suspension is ground

in a DCP Superflow 12 mill (from Drais) for 30 minutes, with an average residence time of 4 minutes. After the end of grinding, 400 g of the above suspension (solids content: 9.68%) are introduced into a 2 l flask with KPG stirrer and, with stirring, are admixed with a solution of 16.6 g of acrylate copolymer (10% vinylimidazole, 90% butyl methacrylate, amine number: 30 mg KOH/g, Mₙ=13 500 g/mol, M_{w}=31 000 g/mol), 14.4 g of methoxypropyl acetate, 1.0 g of n-butyl acetate and 295 ml of isobutanol, the reaction mixture being stirred at 40° C. for 90 minutes. This is followed by a steam distillation, in the course of which 360 ml of organic phase are separated off. During the steam distillation, small beads of pigment, 1-2 mm in size, are formed. These beads are filtered off, washed with water and dried in a drying oven at 60° C. After final dry grinding (in a number of portions, using an IKA M 20 mill), an easily dispersible violet pigment is obtained.

### EXAMPLE 3

100 g of Pigment Orange 36 (C.I. No. 11780, used in presscake form) are admixed with 100 ml of isobutanol in a dissolver with toothed disk and the mixture is dispersed at 1500 rpm for 10 min. Thereafter a solution of 11.2 g of acrylate copolymer (10% vinylimidazole, 90% butyl methacrylate) in methoxypropyl acetate and isobutanol is added and the mixture is stirred at 1500 rpm for a further hour. This is followed by steam distillation to remove the organic solvent. After final filtration, drying at 60° C. and dry grinding (in a number of portions, using an IKA M 20 mill), an easily dispersible orange pigment is obtained.

The pigments produced in Examples 1 to 3 are tested in an alkyd-melamine baking varnish. The varnish system is composed of a grinding varnish, a letdown mixture, and a white paint:

Grinding Varnish:

35% and 50% polyester resin solution in Solvesso 100

Letdown Mixture:

26.4 g polyester resin solution, 29.4 g alkyd resin solution, 35.8 g melamine resin solution, 6.2 g high-boilers mixture, 2.2 g Solvesso 100

White Paint (30%):

Standard white paint based on Kronos TiO₂, polyester resin solution, alkyd resin solution, additives, Solvesso 100

### EXAMPLE I: COMPARATIVE EXAMPLE

The masstone paint was produced by dispersing 21.0 g of alkyd melamine grinding varnish and 9.0 g of Pigment Orange 36 (C.I. No. 11780) together with 85 g of glass beads (3 mm) in a Scandex mixer (BA-S 20, Scandex, Bromma, Sweden) for 30 minutes. Subsequently, with slow stirring using a glass rod, 60 g of letdown mixture are added, followed by dispersion again in the Scandex mixer for 3 minutes. Subsequently the glass beads are removed by filtration.

To produce the white reduction, 6.0 g of the above masstone paint are homogenized with 20 g of alkyd melamine white paint (30%) by means of simple stirred incorporation.

### EXAMPLE II

In a dissolver with toothed disk (VMA-Getzmann GmbH, Reichshof, Germany) 40 g of alkyd-melamine grinding varnish are dispersed with 20 g of the easily dispersible pigment from Example 3 at 3800 rpm and 50° C. for 30 minutes. 10 g of this pigmented grinding varnish are then admixed gradually, with slow stirring using a glass rod, with 20 g of letdown mixture at room temperature.

To produce the white reduction, 6.0 g of the above masstone paint are homogenized with 20 g of alkyd-melamine white paint (30% TiO₂) by means of simple stirred incorporation.

### EXAMPLE III, COMPARATIVE EXAMPLE

To produce the masstone paint, 26.4 g of alkyd-melamine grinding varnish and 3.6 g of C.I. Pigment Violet 23 (C.I. No. 51319, Hostaperm Violet RL spec.) are dispersed together with 85 g of glass beads (3 mm) in the Scandex mixer for 30 minutes. Thereafter, with slow stirring using a glass rod, 60 g of letdown mixture are added, followed by renewed dispersion in the Scandex for 3 minutes. Subsequently the glass beads are removed by filtration.

For the white reduction, 7.5 g of the above masstone paint are homogenized with 20 g of alkyd melamine white paint (30% TiO₂) by means of simple stirred incorporation.

### EXAMPLE IV

In a dissolver, 49.7 g of alkyd-melamine grinding varnish are dispersed with 10.3 g of easily dispersible violet pigment (Example 1) at 50° C. and 3800 rpm for 30 minutes. 10 g of this pigmented grinding varnish are then admixed gradually, with slow stirring using a glass rod, with 20 g of letdown mixture at room temperature.

For the white reduction, 7.5 g of the above masstone paint are homogenised with 20 g of alkyd-melamine white paint (30% TiO₂) by means of simple stirred incorporation.

The easily dispersible pigments exhibit a significantly higher color intensity in the alkyd-melamine varnish in comparison to the conventional pigments. The table shows the resultant color intensity of the respective pigment in an alkyd-melamine varnish following appropriate white reduction.

| | Type of dispersing in grinding | |
|---|---|---|
| Example | varnish | Color intensity |
| III | Scandex mixer | 100% |
| IV | Dissolver | 122% |

### EXAMPLE V

The color intensity determined as a function of dispersing time shows that the easily dispersible, surface-coated pigments develop a higher color intensity in an alkyd-melamine varnish, when dispersed in a Scandex mixer (Scandex, Bromma, Sweden) for the same dispersing time and type, than the Hostaperm Violet RL spec. (Clariant) reference pigment. The difference in pure-pigment concentration was taken into account in this series of experiments and was compensated by means of a higher pigment concentration in the case of the surface-coated, easily dispersible pigments.

Procedure:

26.4 g of alkyd-melamine grinding varnish and 3.6 g of Hostaperm Violet RL spec. are each dispersed together with 85 g of glass beads (3 mm) in the Scandex mixer for 15, 30 and 60 minutes, respectively. Thereafter, with slow stirring using a glass rod, 60 g of letdown mixture are added and dispersion is repeated in the Scandex mixer for 3 minutes. Subsequently the glass beads are removed by filtration. To produce the white reduction varnish, 7.5 g of the above masstone varnish are admixed with 20 g of an alkyd-melamine reduction varnish (30% TiO₂) and the mixture is homogenized.

With the surface-coated pigment (Example 1) a similar procedure is carried out, but using 5.1 g of pigment (corresponding to 3.6 g of pure pigment) and 24.9 g of grinding varnish.

| | | | Color |
|---|---|---|---|
| | Color intensity | Color intensity | intensity |
| Pigment | after 15 min | after 30 min | after 60 min |
| Hostaperm Violet | 87 | 97 | 100 |
| RL spec. (Clariant) | | | |
| Example 1 | 100 | 100 | 100 |

1) A method of pigmenting a solventborne, nonaqueous organic coating material comprising the steps of incorporating a finely divided organic pigment coated with at least one amino-containing (meth)acrylate copolymer into a solventborne organic coating material with an energy input reduced by at least 20% as compared with the corresponding uncoated pigment.

2) The method of claim 1, wherein the organic coating material is a solventborne baking varnish or a solventborne two-component varnish.

3) The method of claim 1, wherein the organic coating material is an alkyd-melamine resin varnish, acrylic-melamine resin varnish, polyester varnish or high-solids acrylic resin varnish.

4) The method of claim 1, wherein the organic coating material is a printing ink or ink-jet ink.

5) The method of claim 1, wherein the organic pigment is a pigment selected from the group consisting of azo pigments, Naphtol, benzimidazolone, metal complex pigments, and polycyclic pigments.

6) The method of claim 1, wherein the at least one amino containing (meth)acrylate copolymer has a molar mass of between 2000 and 100 000 g/mol.

7) The method of claim 1, wherein the at least one amino-containing (meth)acrylate copolymer has an amine number of between 20 and 70 mg KOH/g.

8) The method of claim 1, wherein the finely divided organic pigment coated with at least one amino-containing (meth)acrylate copolymer is obtained by mixing an aqueous, finished presscake of the organic pigment with water, deagglomerating the water and presscake in a static mixer in the presence of the at least one amino-containing (meth)acrylate copolymer to form a deagglomerated mixture, subjecting the deagglomerated mixture to steam distillation to form a solid, isolating the solid by filtration, and drying the solid to form a coated pigment.

9) The method of claim 8, wherein the deagglomerating step deagglomerates the organic pigment to a particle size distribution of 0.1 to 10 μm.

10) The method of one claim 1, wherein the at least one amino-containing (meth)acrylate copolymer is applied to the organic pigment in an amount of 5% to 50% by weight, based on the total weight of the coated pigment.

11) The method of claim 1, wherein the organic pigment is selected from the group consisting of monoazo, diazo, isoindolinone, isoindoline, anthanthrone, thioindigo, thiazineindigo, triarylcarbonium, quinophthalone, anthraquinone, dioxazine, phthalocyanine, quinacridone, quinacridonequinone, indanthrone, perylene, perinone, pyranthrone, diketopyrrolopyrrole, isoviolanthrone and azomethine pigments.

12) A pigmented solventborne nonaqueous organic coating material made in accordance with the method of claim 1.

13) The pigmented solventborne nonaqueous organic coating material of claim 12, wherein the organic coating material is a baking varnish, two component varnish, a printing ink or ink jet ink.
